(19) United States
(12) Patent Application Publication
(10) Pub. No.: US 2006/0149640 A1
(43) Pub. Date: Jul. 6, 2006

(54) Integrating electronic and traditional retail

(76) Inventors: Sheldon M. Gordon, Greenwich, CT (US); Scott J. Gordon, Greenwich, CT (US); Antony H. Lee, Greenwich, CT (US); Ann L. Gambardella, Fairfield, CT (US); Camilo E. Cucalon, Somers, NY (US)

Correspondence Address: COLEMAN SUDOL SAPONE, P.C., 714 COLORADO AVENUE, BRIDGE PORT, CT, 06605-1601, US

(21) Appl. No.: 11/223,328

(22) Filed: Sep. 9, 2005

Related U.S. Application Data
(60) Provisional application No. 60/609,073, filed on Sep. 10, 2004.

(51) Int. Cl. G06Q 30/00; G06K 15/00

(52) U.S. Cl. 705/26; 235/383

(57) ABSTRACT

A business method utilizes a dedicated electronic shopping network having a database and wireless receiving and transmitting components. The network is provided at a retail-type architectural facility where space is rented to a plurality of independent retail entities. For each respective one retail entity, data pertaining to goods offered for sale by the respective one entity is loaded the database. Queries from hand-held electronic personal shopping devices pertaining to goods offered for sale by the retail entities are received via the wireless receiving components. The wireless transmitting components transmit, to the hand-held electronic personal shopping devices, data from the database responsive to respective queries.

### BACKGROUND

Various aspects of the invention relate to retail stores, shopping areas, electronic retail commerce, and traditional retailing.

U.S. patent application Ser. No. 09/542,580 discloses a retail store or a collection of stores and a method of operating a retail store or collection of retail stores within a mall environment. A display stock of goods representative of the goods offered by any given one of the stores is arranged for display to customers that enter the store. For some or most of the offered goods, the given store may have essentially no inventory for immediate possession by customers. A self-serve electronic display terminal is provided at which a customer can choose from among the offered goods, and tender payment for the chosen goods.

Embodiments of the retail method disclosed in U.S. patent application Ser. No. 09/542,580 incorporate one or more of the following features. The display stock may be chosen to cover a representative sample of all goods offered by the retail store, being less than one exemplar for each distinct good or combination of features offered. The store or stores may provide a pick-up center from which a customer may specify pick-up of chosen goods. The average size of a store of the retail area may be less than about half the average size of a store for a traditional shopping mall in a similar location. Walls between adjoining stores may include an opening through which customers may pass between stores without passing through a common area. Each retail store may include a self-serve electronic display terminal at which a customer can choose from among the goods offered by the store, and tender payment for the chosen goods. Each electronic display terminal may be under control of software controlled by the retail store that includes the electronic display terminal. Electronic display terminals may be placed in a common area of a retail shopping area including two or more retail stores. The electronic display terminal may be designed to provide the capability to a customer to choose from among the goods offered by any of the retail stores of the area, and tender payment for the chosen goods. The electronic display terminal; may be connected to the public Internet. The electronic display terminal may be designed to prevent the electronic display terminal from browsing pages other than those related the retail area and the stores of the area. The electronic display terminal may be connected to an intranet. Software for allowing the customer to choose from among the offered goods may reside on an intranet server controlled by the retail store. An electronic unit to be held by a customer may include significant memory and a computer processor programmed to store selections indicated by the customer in the memory. A server computer may maintain a database of customers of the retail shopping area. The database may have space to record at least one payment account and at least one preferred mode for delivery for each customer in the database. Computers for several retailers of the retail may have shared access to the customer database. The computer database may maintain the value of a stored value card purchased by a customer. Value may be debited from the stored value as the customer makes purchases within the retail shopping area. The customer database may be indexed by a number obtainable from mobile phones of the customers. One or more electronic display terminals may provide the customer the capability of specifying a mode for delivery of the chosen goods. Modes that may be specified might include a destination to which the chosen goods are to be delivered, or a carrier to deliver the chosen goods.

### OBJECTS OF THE INVENTION

It is an object of the present invention to provide an improved retail method for combining methods of traditional retailing and methods of electronic commerce.

It is another object of the present invention to provide such a retail method that facilitates the purchase of goods by a consumer from multiple different retailers.

Another object of the present invention is to provide a method that facilitates the display of goods at retail locations by retail entities having no access to traditional brick-and-mortar retailing.

Yet another object of the present invention is to provide an associated retail system.

Yet a further object of the present invention is to provide an electronic personal shopping device (PSD) that facilitates the shopping experience.

These and other objects of the present invention will be apparent from the descriptions and drawings herein. Although every object of the invention is believed to be attained by at least one embodiment of the invention, there is not necessarily any one embodiment that achieves all of the objects of the invention.

### SUMMARY OF THE INVENTION

A business method comprises, in accordance with the present invention, (a) providing a dedicated electronic shopping network having a database and wireless receiving and transmitting components, (b) providing a retail-type architectural facility, (c) renting out space in the facility to a plurality of independent retail entities, (d) for each respective one of the retail entities, loading into the database data pertaining to goods offered for sale by the respective one of the retail entities, (e) receiving, via the wireless receiving components, queries from hand-held electronic personal shopping devices pertaining to goods offered for sale by the retail entities, and (f) transmitting, via the wireless transmitting components, to the hand-held electronic personal shopping devices (PSDs), data from the database responsive to respective ones of the queries.

Pursuant to a further feature of the present invention, the method also comprises (g) receiving, from a given one of the personal shopping devices via the wireless receiving components, a purchase request including a specification of delivery particulars and payment particulars, (h)) electronically relaying the payment particulars to a specified financial institution, and (i) confirming payment completion to the given one of the personal shopping devices via the wireless transmitting components. Where the dedicated electronic shopping network includes a server computer having a connection to the Internet, the relaying of the payment particulars includes operating the server computer to communicate with a computer of the specified financial institution via the Internet. The financial institution may take the form of a bank, while the payment particulars include a credit or debit card number. Where the purchase request includes a listing of goods sold by different retail entities, the relaying of the payment particulars may include a specification of amounts due to the different retail entities. The payment particulars includes a single total amount entailing a single monetary transfer.

The present invention contemplates that any electronic communication with computers or other devices via the Internet is mediated through a server computer of the dedicated electronic shopping network. Generally, personal shopping devices may not be used to access the Internet, for example, to download Web pages or transfer email messages. Instead, the personal shopping devices are blocked from having direct access to the Internet via the dedicated electronic shopping network. While it is possible for a hand-held electronic device to be provided with separate programming for enabling a direct link to the Internet, that functionality is not mediated through the dedicated electronic shopping network as discussed herein.

The present invention contemplates a method for facilitating the opening of physical retail “stores” by Internet retailers and catalogue or mail-order companies, as well as by foreign concerns that do not have the wherewithal to establish a brick-and-mortar type facility in this country. To that end, the renting out of space in the facility includes providing a package of support services to the retail entities, the package including services taken from the group consisting of decor or design services, construction services, personnel services, tax and regulatory services, and delivery services. This approach to providing space and services to retailers can greatly enhance the abilities of Internet retailers, catalogue or mail-order companies, foreign concerns, and small retail entities to get samples of their products in the hands of the purchasing public. Typically, the retail locations as contemplated herein do not carry inventory for sale. Instead, only samples are displayed for potential customers to better appreciate the nature and quality of the goods that is possible via a pictorial representation, whether communicated via the Internet or a paper catalogue.

Pursuant to a further feature of the present invention, any given personal shopping device may store at least one delivery option selectable by the individual owner of the given personal shopping device and transmittable to the electronic shopping network to specify delivery particulars.

A related electronic shopping system comprises, in accordance with the present invention, a dedicated electronic shopping network having a database and wireless receiving and transmitting components, the receiving and transmitting components being disposed in operative proximity to a retail-type facility housing retail displays of a plurality of independent retail entities. The network includes a dedicated database storing data pertaining to goods offered for sale by the retail entities. The network includes software for fielding queries received, via the wireless receiving components, from hand-held electronic personal shopping devices pertaining to goods offered for sale by the retail entities, and further includes software for transmitting, via the wireless transmitting components, to the hand-held electronic personal shopping devices, data from the database responsive to respective ones of the queries.

The dedicated electronic shopping network is programmed with software for recognizing a purchase request received from any given one of the personal shopping devices via the wireless receiving components. The software includes programming for recognizing delivery particulars and payment particulars, electronically relaying the payment particulars to a specified financial institution, and confirming payment completion to the given one of the personal shopping devices via the wireless transmitting components.

The dedicated electronic shopping network may include a server computer having a connection to the Internet for communicating with a computer of the specified financial institution via the Internet. The dedicated electronic shopping network is preferably provided with software for blocking the personal shopping devices from having direct access to the Internet via the dedicated electronic shopping network.

The dedicated electronic shopping network includes programming for processing a purchase request including a listing of goods sold by different retail entities, and for relaying the payment particulars including a specification of amounts due to the different retail entities, the payment particulars including a single total amount entailing a single monetary transfer for each retailer included in the purchase.

At least a given one of the personal shopping devices stores personal identification information pertaining to at least one individual authorized to use the given one of the personal shopping devices. The given personal shopping device may additionally store at least one delivery option selectable by the one individual and transmittable to the electronic shopping network to specify delivery particulars. Preferably, however, the personal shopping devices are just simple non-intelligent devices which talk to a central server on which all of the information is stored during the shopping visit.

A personal shopping device comprises, in accordance with the present invention, a hand-held casing, a scanner mounted to the casing for reading product codes on displayed products, a wireless receiver mounted to the casing, a wireless transmitter mounted to the casing, a manual input interface on the casing, and a control microprocessor. The microprocessor is mounted to the casing, is operatively coupled to the scanner, the receiver and the transmitter, and is programmed to (a) receive, from a dedicated electronic shopping network, product information pertaining to products identified via the scanner, (b) construct a list of items identified via the scanner, and (c) transmit, to the dedicated electronic shopping network, a single purchase request for multiple items on the list. A display is mounted to the casing and operatively coupled to the microprocessor for displaying product information received from the dedicated electronic shopping network. The microprocessor includes a memory and software for storing personal identification information pertaining to a user of the device.

A shopping method comprises, in accordance with the present invention, providing a hand-held electronic personal shopping device, visiting a retail location provided with a dedicated electronic shopping network, and operating the personal shopping device to wirelessly transmit a request to the dedicated electronic shopping network for information pertaining to an identified product on display at the retail location. The personal shopping device is further operated to wirelessly receive the requested information from the dedicated electronic shopping network and to communicate the received information. The method also comprises generating a list of goods to be purchased and transmitting a single purchase request for goods on the list.

The goods may generally include goods sold by different retail entities.

The transmitting of the purchase request may be to the dedicated electronic shopping network and may be performed at the retail location. Alternatively, the transmitting of the purchase request may be via the Internet from a location remote relative to the retail location. In the latter case, the shopper constructs the list of desired goods at the shopping facility and stores the list on the central server to be accessible from the handheld, a kiosk, or a cash register in the store. By scanning a barcode or other identifier on the personal shopping device, the shopping cart loaded via that device can be transmitted to a kiosk or cash register for completion of the purchase. The purchase may be completed, for instance, at the shopper's home by connecting the personal shopping device to a computer having Internet access, logging in to the website using a user ID and PIN established while shopping at the retail area.

Alternatively, a customer can start a shopping session using the handheld personal shopping device and finish the shopping session at a kiosk. The customer has the ability to scan all her items for take-home, walk to a printer or a self-checkout kiosk, scan the device and obtain a receipt immediately.

In another alternative configuration of an electronic shopping system, the technology is licensed to a specific retailer with a geographic dispersion of retail locations. In this case, there can be a “cross-use” of handheld personal shopping devices among multiple retailer locations. For example, the customer may save a shopping session she started at one of the retailer's stores, and finish it at a different retail location.

For security purposes, at a kiosk a shopper assistant can scan a customer's receipt and perform a quick audit on the customer's handheld personal shopping device.

The customer has the ability to scan items into a personal shopping device—for home delivery or take home—then take the device to a traditional cash register (POS) or mobile POS handheld device. At the register, a sales associate can scan an ID on the customer's device, or scan her POS device with the customer's handheld, thereby transferring the shopping cart to the POS. At that point, the sales associate can finish the transaction for the customer.

At the cash register, the sales associate can access a customer's profile, retrieving address book information, as well as various credit cards that the customer may have entered into her profile. This makes it easier for sales associates to place orders for customers at the cash register.

A business method comprises, in accordance with the present invention, providing a retail-type architectural facility and renting out space in the facility to a plurality of independent retail entities. The renting out of space in the facility includes providing a package of support services to each of the retail entities, the where package includes design services, construction services, personnel services, tax and regulatory services, and delivery services. For each of the retail entities, samples of a plurality of different products are received and displayed in the facility.

Preferably, this method further comprises providing a dedicated electronic shopping network having a database and wireless receiving and transmitting components and for each respective one of the retail entities, loading into the database data pertaining to respective displayed product samples.

This method may further comprise receiving, via the wireless receiving components, queries from hand-held electronic personal shopping devices pertaining to goods offered for sale by the retail entities, and transmitting, via the wireless transmitting components, to the hand-held electronic personal shopping devices, data from the database responsive to respective ones of the queries.

These attributes, advantages and features are of representative embodiments only. Additional features and advantages of the invention will become apparent in the following description, from the drawings, and from the claims.

### BRIEF DESCRIPTION OF THE DRAWING

FIG. 1 is a perspective view of the interior of a retail facility.

FIG. 2 is a plan view of a retail area.

FIG. 3 is a flow chart.

FIG. 4 is a perspective view of a customer a retail area.

FIG. 5 is a block diagram of a personal shopping device in accordance with the present invention.

FIG. 6 is a diagram of a distribution system utilizable as part of an el ectronic shopping system in accordance with the present invention.

### Definitions

The term “retail entity” is used herein to designate an individual, a company or other legal entity in the business of selling goods the consuming public. A retail entity may be a traditional brick-and-mortar retailer, an Internet retailer, a catalogue or mail order company, etc.

The term “retail-type facility” or “retail location” is used herein to denote a building or other structure that is usable by retail entities to display sample products. The retail entities may or may not maintain inventory at the retail location or facility for purchase-and-carry acquisition by consumers.

The term “dedicated computer shopping network” or “dedicated electronic shopping network” (DSN) as used herein denotes a generally closed or private computer network that is accessible via interface devices (computers, PDAs, cell phones, and personal shopping devices) by consumers at a retail location or facility. Generally, the DSN infrastructure is located on or near the premises of the retail location or facility. The DSN includes a database that stores information pertaining to goods sold by retail entities at the retail location of facility. Typically, the DSN does not store information pertaining to goods that are not displayed at or available for purchase-and-carry acquisition at the retail location or facility. The personal shopping devices that access the DSN, which include computers, PDAs, and cell phones, that are programmed for such access, are typically connected to the DSN via a wireless link. The DSN may have access to the Internet; however, this access is generally limited to a server computer of the DSN. The computers, PDAs, cell phones, and personal shopping devices that access the DSN are not permitted to access the Internet via the DSN. Thus, consumers are not able to browse Internet Web sites or send or receive email via the DSN. Dedicated personal shopping devices, that is, devices that have no function other than enabling shopping via a DSN, cannot access the Internet at all. Of course, other kinds of hand-held devices such as cell phones that are also programmed for use as personal shopping devices will be able to access the Internet directly. However, such access is not via the DSN.

The term “personal shopping device” (PSD) is used herein to denote a hand-held electronic device specially programmed for assisting a shopper in obtaining information about goods on display in a retail location, for forming of list of items to be purchased, for selecting and/or specifying particulars as to delivery of the selected items, and for tendering payment for the selected items. Where at least some goods are available on a cash-and-cary basis, the PSD may specify that some purchased goods are to be taken home directly from the retail location, while other purchased goods are to be delivered to one or more locations. The PSD includes a scanner for reading product codes disposed on displayed goods at the retail location. The scanner may take the form of a laser scanner of a type commonly used in conventional retail stores for scanning bar codes. The PSD additionally includes wireless transmitting and receiving hardware and related software for enabling a user to transmit requests to a dedicated computer network for information pertaining to items on display at the retail location and to receive or download the requested information from the dedicated computer network. In some embodiments of an electronic shopping network, the PSD may be used to communicate with other handheld devices, kiosks, POS (point-of-sale) systems and retailers' data centers. The PSD also includes a keypad or other input modality and a display and/or an electroacoustic transducer for communicating information visually and/or aurally to the user. The PSD may be retained at the retail location for use by different customers in seriatim. Alternatively, the PSD may be adapted to use by a single individual who carries the PSD with him or her, possibly to different malls or shopping centers each of which may be provided with a dedicated electronic shopping network. The PSD may include hardware and/or software for performing other functions, such as photographic or telephonic functions, music storage and playback, data storage and retrieval functions, etc. The PSD may include security components for identifying a user, for example, via a personal identification number or via more sophisticated means such as fingerprints, retinal scans, or DNA analysis.

A PSD as disclosed herein may be programmed to enable a customer to do self-checkout of both take-home and orders for shipment in a single shopping session on the handheld. An electronic shopping system will perform the single checkout on the handheld PSD using customer information (address, shipping, payment account numbers, etc.) on file.

The term “design services” as used herein refers to services used in planning retail display layout and decor, arranging product displays, producing and disposing signs and banners, and coordinating colors.

The term “construction services” as used herein refers to building and assembling of retail displays.

The term “personnel services” as used herein refers to services for hiring, training, supervising, and compensating human shopping assistants. Such shopping assistants would be hired, for instance, to assist shoppers at a retail location and/or to receive product returns. Personnel services include time keeping, the selection and administration of health benefits, instruction in the use of PDA and DSN technology, and instruction in retail sales activities.

The term “tax and regulatory services” as used herein refers to services for assisting retail entities in complying with various tax and regulatory requirements incidental to the business of selling goods to consumers.

The term “delivery services” as used herein refers to activities undertaken in transferring goods from retail entities to purchasing consumers and in returning goods to retail entities from consumers.

The term “blocking access” when used in connection with electronic personal shopping devices and the Internet means that the PSDs are not enabled or are prevented from downloading information from or transmitting information via the Internet, with the possible exception of purchase payment information (credit card number, expiration date, purchase amounts and payees, etc.). In such an embodiment of an electronic shopping system, PSDs are not able to access Web pages and other types of files via the Internet to the send or receive email. The communication of purchase payment information takes place via a server of a DSN.

### DETAILED DESCRIPTION

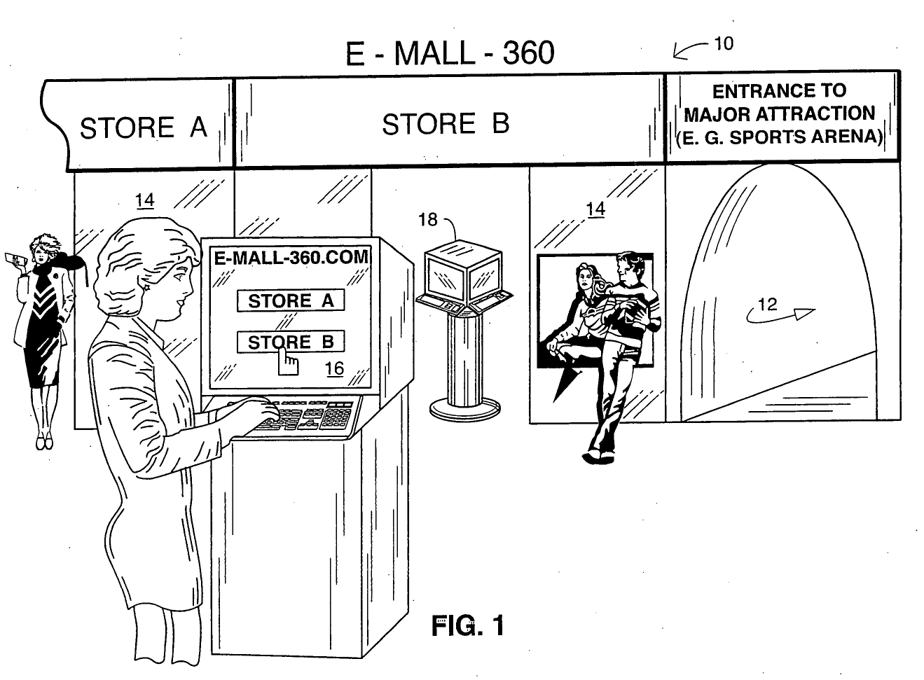

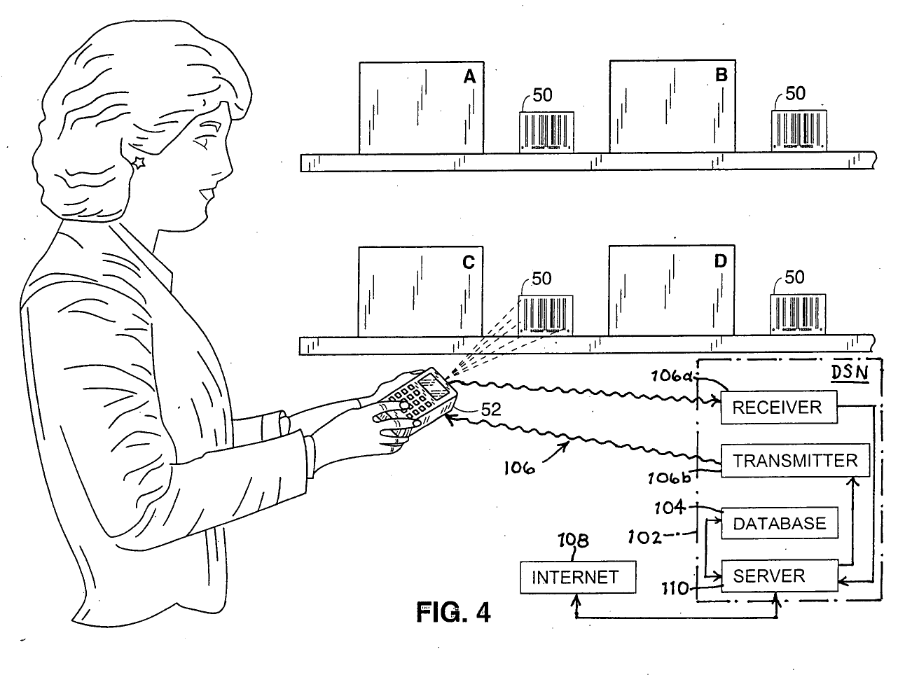

As illustrated in FIG. 1, a retail facility or location 10 offers a shopping area in which customers make purchases through customer-operated electronic purchasing stations or kiosks 16, 18. Alternatively, customers make purchases with a hand-held electronic personal shopping device (PSD) 52 discussed in detail hereinafter with reference to FIG. 4.

Optionally, retail facility 10 may be located next to, or combine, a major entertainment attraction 12, which may be anything that draws many people, such as an arena or sports stadium, an airport terminal, a boat landing, a beachfront, a resort, a gambling casino, a horse race track, an historical or cultural attraction, a theme park, etc.

Some or all of the individual stores 14 in retail area 10 may be no-inventory or low-inventory walk-in display showcases. In the showcase stores, merchandise is displayed for customers to touch, study, sample, try on, color match, inspect, and the like, but there is no requirement for maintaining stocks of the articles being sold for customers to carry away immediately. Purchasing stations 16, 18 and PSD 52 provide access to a dedicated electronic shopping network (DSN) 102. Network 102 is a closed or private computer network having an infrastructure located on or near the premises of the retail facility 10. Network 102 has a database 104 loaded with information supplied by retail entities who occupy space in retail facility 10. The information in the database 104 of network 102 pertains particularly to goods that the retail entities have on display in retail facility 10. Typically, the DSN network 102 does not store information pertaining to goods that are neither displayed at nor available for purchase-and-carry acquisition at the retail location or facility. The PSDs 52 that access the DSN 102 are typically connected to the DSN via a wireless link 106 including a transmitter 106a and a receiver 106b. The DSN 102 may have access to the Internet 108; however, this access may be limited to a server computer 110 of the DSN 102. In that case, PSDs 52 that access the DSN 102 are not permitted to access the Internet 108 directly. Thus, consumers are not able to browse Internet Web sites or send or receive email via the DSN 102. In an alternate embodiment of a networked shopping system, PSDs 52 may access the Internet 108 directly. In either case, the Internet 108 may be used for direct or indirect communications between handheld devices 52, kiosks 16 and 18, point-of-sale (POS) systems (cash registers, etc.), retailers' data centers, and a central computer (not shown) administering a network of DSNs 102. Accordingly, PSDs 52 could access the Internet 108 when authorizing payment for take-home purchases.

As depicted in FIG. 4, display samples may be accompanied by “smart” shelf tags 50 that interact with PSDs 52 to assist in the purchase process. For instance, each product offered for sale may have a corresponding shelf tag 50 that bears a bar code or other machine-readable information, for instance, a UPC panel obtained from packaging for the product, and PSD 52 may include a bar-code scanner. Alternatively, shelf tags 50 may include infrared detectors, and PSD 52 may emit infrared signals, analogous to those emitted by a television remote control or cellular telephone.

When the customer finds an item in which he or she may have an interest, he/she may point PSD 52 at the smart shelf tag 50 for the desired item. Pushing additional buttons or keypads on PSD 52, the user may access relevant product information that is stored in database 104 of DSN network 102. Alternatively or additionally, the user may operate PSD 52 to select the item either for definite purchase, or may be added to a “considering” list for later decision. PSD 52 records what items the customer is interested in, building up a “shopping cart” full of selected merchandise. The selected merchandise may be purchased on site through the PSD 52 and the DSN 102. In that case, the DSN server 110 mediates payment processing and delivery selection via the Internet 108. The PSD 52 may or may not communicate directly with the Internet 108. DSN server 110 wirelessly notifies PSD 52 when a purchase transaction has been completed. A purchase transaction may include items that are cash-and-carry, that is, take-home selections, as well as items that are not available as take-home selections but instead are purchased for later delivery.

When the customer is ready to purchase the desired goods, the customer may transmit a purchase request wirelessly to server 110 of DSN network 102. The purchase request typically includes a list of goods, the retail entities that are showcasing the goods in facility 10, the costs of the respective goods in the purchase list, and a total cost, as well as payment particulars such as a credit card number. For showcase-only items, the purchase request also typically includes at least one delivery method and destination address. The customer may place the purchase request when he or she is ready to leave retail facility 10. In other embodiments, or at the choice of the customer, a customer may alternatively purchase goods as he/she leaves each retailer 14. In embodiments where the customer's purchase interests were recorded in a memory of PSD 52, data about the selected merchandise may be uploaded to a specialized Internet Web site from PSD 52 at a later time, after the customer leaves retail facility 10. At home the user may connect PSD 52 (e.g., via a USB port) to a desk-top or laptop computer and use information from the PSD 52 to place an order over the Internet 108. In one embodiment, however, PSD 52 is not usable outside of the retail area, and the dedicated network 102. All unpurchased shopping carts are transmitted to the central server for the website and can be accessed from the customer's home, as long as the customer has provided a user ID and PIN during his or her shopping visit. The customer may obtain further information on the selected items, and either confirm the purchases, or remove them from the shopping cart. The customer may select some, all, or none of the selected items for purchase.

The above-described home use of PSD 52 presumes that the device may be carried out of retail facility 10 by a user. In that case, PSD 52 is personal to and perhaps owned by the user. The user may enter personal identification information into PSD 52, such as a personal identification number.

In advanced embodiments, particularly where PSD 52 is supplied to the customer for use only in a given retail area, PSD 52 may include components for implementing other techniques of identification, for instance, fingerprint recognition, voiceprint identification, retinal scans, or DNA analysis. All these identification techniques are meant to ensure that the PSD 52 cannot be used by a person other than an authorized user.

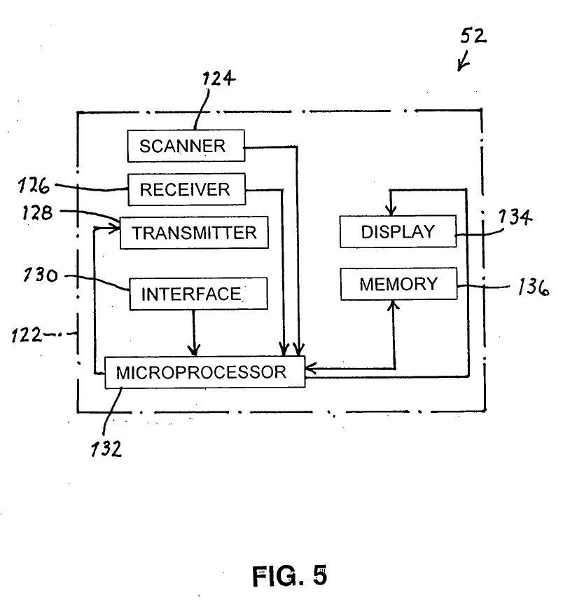

In other embodiments, PSD 52 is owned by retail facility 10 or an administrative entity (natural person or legal entity) related to the retail facility. In this case, PSD 52 does not leave the premises of retail facility 10. For a user to access a purchase list from home, it is necessary that the purchase list be uploaded from PSD 52 to server computer 110 of DSN network 102. The customers also provide respective user IDs and PINs, so that they can access their purchase lists at home on the website. If a customer wishes to defer a purchase decision, the customer may select some merchandise to purchase, possibly some to think about for a few hours or days, until he/she can make the purchasing decisions at home, or, the customer may wish to consult with other family members. Alternatively, shelf tags 50 and hand-held PSD 52 may be used to build up a “wish list,” for instance for a gift-giving holiday, or as a gift registry for a special occasion, or as a way for a person to discretely convey gift preferences to friends. The selected merchandise may be stored in the retail area's customer database 60 (discussed below with reference to FIG. 5). The individual who selected the merchandise may edit the wish list either at a purchasing station 16, 18, or over the Internet. The wish list may be emailed to donors, or gift donors can obtain access to the wish list through the retail area web site. The donors may make their purchases through the retail area web site, or by responding to the e-mail, or the donor may go to the physical retail area to view the selected items.

A child may use hand-held device 52 to select a “wish list” during a single shopping trip, and then a parent may review the list with the child to make a final selection for purchase. The review may be undertaken via the PSD itself (enable to accept purchase request only from adult owner) or at a purchasing station 16, 18 within retail area 10, or may occur at home over the Internet. If at a purchasing station, 16, 18, the customer scans a barcode provided on the back of the PSD 52, and the wish list is then transmitted to the kiosk from the central server 110.

Where the hand-held PSD 52 is personal to the user and transportable out of facility 10 by the user, the PSD may store one or more shipment addresses and delivery methods that may be uploaded to server 110 of DSN network 102 as part of a purchase request.

Personnel may be provided in stores 14 for answering questions, accepting returns, providing customer service and support, assisting with the electronic purchasing stations 16, 18, and PSDs 52 and the like. These roving (or stationary) shopping assistants may carry handheld electronic devices (not separately illustrated) with barcode scanners for scanning products and completing the checkout process for customers “on the spot.” Merchandise purchased at purchasing stations 16, 18 or via PSD 52 or with the help of human shopping assistants is delivered as requested by the purchasing customer, e.g., typically to home or work.

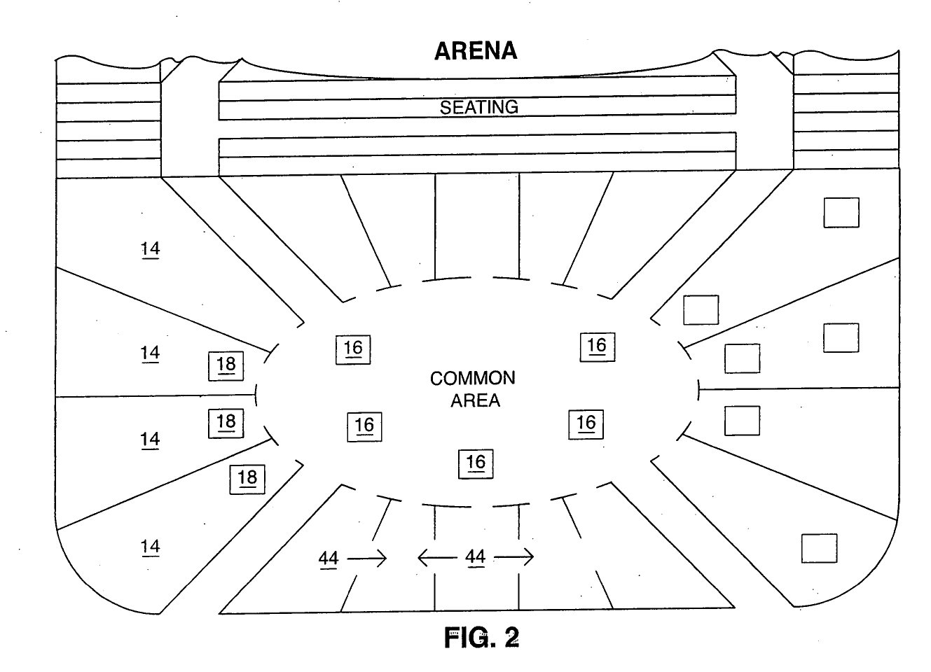

As illustrated in FIG. 2, one type of retail facility provides a number of retail stores 14 arranged to facilitate access. Each store 14 is relatively small, about 3,000 to 4,000 square feet, or may be about half the size of a store that would stock a similar range of merchandise, although the size may vary as warranted.

Each store 14 may be defined in part by walls or partitions or, particularly in the case of small store areas, by a decor and design layout that identifies the store and sets it apart from other stores in the immediate vicinity. The decor and design may be provided by the owner or a management company that oversees space rental and provides services to the commercial tenants, i.e., the retail entities whose goods are displayed in stores 14. Decor and design services may be provided to tenants and prospective tenants as part of a service package also including construction services, personnel services, tax and regulatory services, and delivery services. Decor and design services include the planning of retail display layout and decor, the arranging of product displays, the producing and disposing of signs and banners, and the coordinating of colors in the retail stores 14. Construction services include the building and assembling of retail displays in the retail stores 14. Personnel services include hiring, training, supervising, and compensating human shopping assistants and any other necessary store personnel. Personnel services further include time keeping, the selection and administration of health benefits, instruction in the use of PDA and DSN technology, and instruction in retail sales activities. Tax and regulatory services include assisting retail entities in complying with various tax and regulatory requirements incidental to the business of selling goods to consumers. Delivery services includes activities undertaken in transferring goods from retail entities to purchasing consumers and in returning goods to retail entities from consumers.

The above-described service package provided to tenants and prospective tenants of facility 10 greatly facilitates the entry of e-commerce companies, Internet retailers, mail-order houses, and catalogue retailers into brick-and-mortar-type retailing. These retail entities may have little or no wherewithal to undertake all of the activities required to establish a physical presence in a brick-and-mortar retail environment. The provision of a package of services including design services, construction services, personnel services, tax and regulatory services, and delivery services enables these retail entities to establish physical retail stores 14 at a much reduced cost relative to traditional brick-and-mortar-type retailing. E-commerce companies, Internet retailers, mail-order houses, and catalogue retailers are thus provided with a turn-key type of experience in establishing retail stores 14 and may use their own pre-established back-office infrastructure to make sales to consumers using PSDs 52 in retail facility 10.

The package of services provided to tenants and prospective tenants of facility 10 includes the loading of the tenant's and prospective tenant's product information into database 104 so that consumers using PSDs 52 can obtain the information they desire and make purchases via DSN network 102.

The package of services provided to tenants and prospective tenants of facility 10 will also assist traditional brick-and-mortar retailers in opening additional outlets, for example, in locations remote from the retailers' home base of operations and in locations that may not support a full-fledged traditional retail store with purchase-and-carry inventory. The package services serve to benefit foreign retail entities in particular. The opening of a showcase retail store 14 in facility 10 involves much less expense and capital investment than opening a traditional retail outlet. It is only necessary that the retailer have a back-office infrastructure capable of supporting sales to consumers in retail facility 10.

Retail facility 10 may be located in a stand-alone architectural structure or next to an existing or co-developed major attraction 12, where major attraction 12 will generate high foot traffic of potential customers attracted to major attraction 12 for a primary purpose other than shopping—these customers may opt to have their selections delivered, rather than carrying them to major attraction 12.

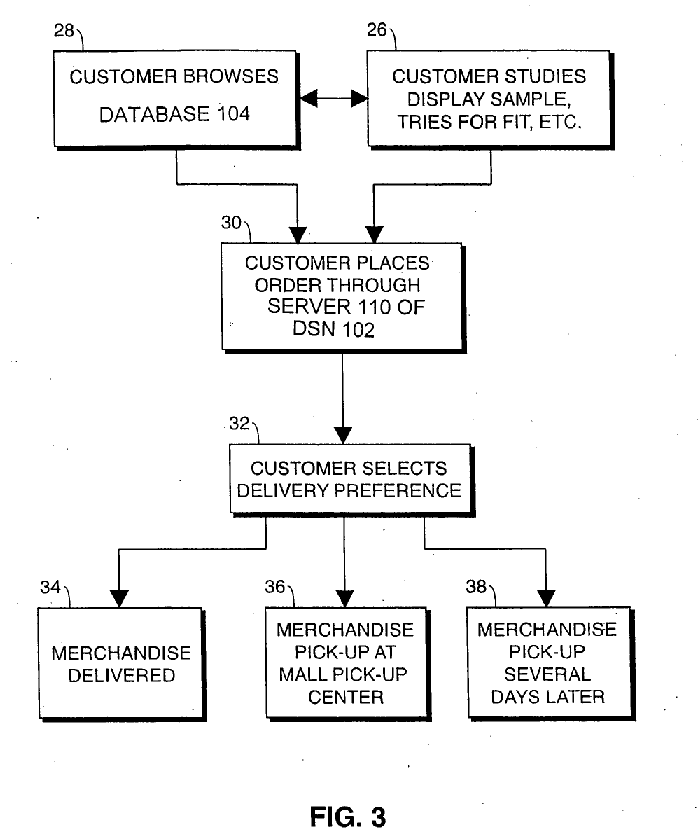

As depicted in FIG. 3, a customer visiting a store 14 in retail facility 10 can view (step 26) physical merchandise. Using PSD 52 (or possibly purchasing station 16, 18), the customer may browse (step 28) database 104 of closed or private network 104 as to the goods on display in any retail store 14. The customer may readily move back and forth between browsing physical merchandise and browsing electronically. When a purchase decision is made, the customer may make final selections (step 30) via PSD 52 (or possibly purchasing station 16, 18) and tender payment from a credit card or cash account, or pay cash. The customer may specify (step 32) that the goods are to be delivered to a specified address (step 34), or in some cases, may specify that the merchandise will be picked up at a pick-up center (step 36), if the retail facility 10 provides this service, or picked up (step 38) at store 14 immediately or a few days later. Because the personnel at showcase-only stores 14 are largely freed from the chores of managing stock, they may be more available to customers to provide a higher level of service both before and after the sale. As discussed above, the payment and delivery particulars are includable in a single purchase request transmitted via PSD 52 to DSN server 110 which then relays details of the purchase request to appropriate parties as warranted. For instance, if the purchase is validated by a financial services company specified in the payment particulars, server 110 can pass the product information and delivery particulars to the respective retail entities. It is possible for different purchased products to be delivered by different routes. For instance, some purchased products might be delivered directly to the customer's home while others are delivered to the retail facility 10 for combination with other purchased items prior to forwarding to the customer's home address or to some other specified address.

With reference again to FIG. 2, the building or architectural structure for retail facility 10 may take the form of a single large space with a high ceiling, with few internal immovable load-bearing walls or other permanent structures. This construction provides flexibility in dividing the space using semi permanent reconfigurable walls and/or design and décor elements. The main floor may be generally at grade, though may be above or below grade as advantageous at a particular site. Truck docks and other service areas may be provided, at or below grade or in a basement. Because the amount of inventory moving through retail facility 10 is less than at a traditional mall, space requirements are reduced for “overhead” purposes such as truck docks, service quarters, internal passageways, etc. Parking may either be provided at grade in the surrounding area, or may be provided in a basement garage, or retail facility 10 may rely on the parking facilities of major attraction 12.

In some instances, a retail facility 10 may be developed with many stores 14, with a higher ratio of storefront to square footage, and a broader offering of merchandise, in a site that is too small or otherwise unsuitable for a traditional shopping mall, or may allow more of these desirable attributes in the same space of a traditional mall. This small size may allow a retail facility to be built in a limited space, for instance, in a dense and expensive urban center or alongside an existing attraction 12 such as a sports arena or transportation terminal.

The individual stores 14 are arranged in any convenient form. For instance, in FIG. 2, stores 14 are arranged as “spokes” radiating from a central courtyard. Alternatively, stores 14 may be rectangular spaces arranged along one or more hallways, analogous to the arrangement of booths at a trade show in a large convention center. In another alternative discussed above, retail stores 14 may be defined by display decor, design, color and product differences relative to nearby stores. The no- or low-inventory operation allows for easier reconfiguration of both the space inside an individual store 14 and reconfiguration of the walls or display decor, design, color, signs, and markers that define stores 14 within retail facility 10.

Stores 14 may be arranged to balance two countervailing concerns: each retailer may have a substantially sized store front facing the common area, to provide space for advertising, etc., but the store fronts should be compact enough so that customers can quickly walk from store 14 to store 14, and visit stores 14 of interest. In some embodiments, the stores may be arranged so that a customer may survey the merchandise offered in numerous retail outlets, possibly dozens, in less time than that required to conduct a similar survey in a traditional mall or other similar traditional retailing environment.

Where a traditional mall is arranged around large “anchor tenants,” retail facility 10 may be arranged around certain “bell cow” tenants, to attract customers into retail facility 10. For instance, for a retail facility next to a museum or casino, restaurants may be especially effective at drawing customers into retail facility 10. For a retail facility near a cruise or airport terminal, merchandise directed to tourists, souvenirs, “signature” goods of the country that may be difficult to obtain in the customers' home countries, or duty-free goods may be especially important. For a retail facility in an urban center, high fashion may be important. The bell cow tenants 14 may be chosen to draw the people already present for major attraction 12 to retail facility 10. Other tenants 14 may be chosen to provide an activity for people that may be accompanying the primary customers. For instance, a retail facility largely directed to women, in which most tenants 14 are retailers of women's ready-to-wear and fashion, may have some stores 14 directed to men, such as The Sharper Image or Hammacher Schlemmer that sell electronics and similar “toys for men,” or men's clothing stores.

Retail facility 10 desirably has at least fifty to seventy tenants 14, but may have more or fewer. The number of tenants 14 should be large enough so that most customers that enter will find at least a few stores 14 of interest, but small enough to preserve the sense that the entire retail facility 10 can be shopped in a limited time.

Where a traditional mall store has a small number of doors that serve as security checkpoints for shoplifting control, no-inventory stores 14 of retail facility 10 can be arranged with flow-through doorways (44 of FIG. 2) between. This flow-through arrangement allows for the creation of an environment qualitatively different than that of the traditional suburban mall.

The individual stores 14 may be referred to as “showcases” rather than “stores,” where their primary function is to display goods, rather than provide for physical transfer of possession. Within each showcase store 14, the space is largely devoted to display. Purchasing stations 16, 18, if provided may be relegated to common areas. Stock space may be reduced or eliminated. Each store 14 has mannequins or other displays, and a small stock of articles for customers to handle, inspect, try on, and the like. For instance, in a clothing store 14 in retail facility 10, one exemplar of each color may be displayed, and one exemplar of each size (independent of color) may be available to be tried on. Alternatively, one exemplar of each color and size may be available. A store 14 that sells, for instance, kitchen items may display one exemplar of each item or class of item. Any remainder of the store's range of offerings may be presented through the company's electronic retail facility or Internet web site.

A customer is presented with the available options in a relatively compact display. For instance, in a traditional store that offers a broad range of competing items—for instance, a kitchen store that offers several dozen models of coffee pots—the amount of space required to display and stock each item is relatively large, so the displays need to be spread out over many square feet, possibly separated from each other by aisles. At a traditional store, a customer may have to search diligently to ensure that all possible choices have been investigated. Because a store 14 of retail facility 10 may have little or no inventory for immediate possessory delivery to customers, the entire range of choices may be presented in a compact display, from which a customer can make a fully-informed choice in less time.

A traditional retail display requires constant monitoring to ensure that stock moves from a stock room to the sales floor in time to keep the floor display from running empty. This restocking may be reduced at retail facility 10. At a store 14 of retail facility 10, the staff is more available to answer questions and provide other customer services, because there is little or no restocking, wrapping, taking money, etc. Some retailers may use a physical store in retail facility 10 to provide traditional customer services, such as merchandise return, to customers that originally made their purchases over the Internet. In embodiments that maintain relatively little inventory, preventive measures and/or insurance for certain inventory-related losses, such as breakage, loss, shoplifting, employee theft, etc. may be reduced. Some retailers may offer customized and/or semi-customized goods.

In some instances, a retailer 14 may choose to offer a physical stock of particular items. For instance, restaurants in retail facility 10 would offer food for immediate consumption, rather than food for next-day delivery. A retailer may use a store 14 of retail facility 10 to clear an overstock of a particular item, just as overstock items are offered at traditional retail stores. Some stores may use traditional retail techniques, while others use no- or low-inventory electronic retail techniques.

In embodiments that operate on no- or low-inventory models, a retailer may be able to more readily alter the selection of merchandise offered, for instance, as the season changes, or as styles change, or as a fad rises and falls.

With reference again to FIG. 1, each electronic purchasing station or kiosk 16, 18 may include a computer, a video display, and one or more input devices. Purchasing stations 16, 18 are designed for ease of use, preferably with little or no training, so that customers can use purchasing stations 16, 18 largely “self-serve,” with minimal assistance from store personnel.

As discussed above, in at least one embodiment of an electronic shopping system, PSDs 52 are not connectable to the Internet 108. Instead, the software of PSDs 52 as well as of DSN network 102 prevents Internet surfing via PSDs 52. Purchasing stations 16, 18, if provided, may similarly isolated from the public Internet. A purchasing station 16, 18 may be arranged as a stand-up kiosk for a customer to use while standing. Other purchasing stations 16, 18 may be arranged for seated use, or for use by persons with physical handicaps. A purchasing station 16, 18 may use a keyboard and mouse as input devices, or may accept touch-screen input.

In some embodiments, the purchasing stations 18 may be provided by individual retailers 14. These purchasing stations 18 may connect to the retailers' computers, either located at retail facility 10, or at the retailer's headquarters. Purchasing stations 18 may connect directly to the same web server that hosts the retailer's web site. Alternatively, server computers at retail facility 10 may host a variant of the retailer's public web site—offering different merchandise, different pricing, different customer service options, etc. Typically the browser software at retailer-private purchasing station 18 has a control to prevent retailer-private purchasing station 18 from connecting to anything other than the retailer's web site.

Common purchasing stations 16 may be provided in the common areas. The top-level home page for these common purchasing stations 16 may be arranged as “index pages” to provide ready access to retailer product information stored on server 110. Common area kiosks 16, as well as kiosks 18 located within the merchant's space, are preferably not connected to the public Internet 108, with the exception of credit card processing. That connection is indirect, mediated or implemented by server computer 110. The kiosks may provide an online catalog for customers to browse through tenant product. All kiosks are connected to the same dedicated server network (DSN) 102.

Checkout at individual retailers 14 may be entirely eliminated. Instead, where purchase requests are placed by means of OSA devices 52, the customer may purchase all of the desired goods at once prior to leaving the effective transmission and reception region of DSN network 102. Alternatively, where stationary purchasing stations or kiosks 18 are used, the customer places a purchase request prior to exiting from retail facility 10, generally at a common purchasing station 16. Kiosks and cash registers within an individual retailer's space are configured to only process that merchant's products. Common area kiosks 16 are the only places where one can order and arrange payment for product across merchants. Purchases from the retail facility retailers are posted separately for each retailer and delivery is arranged from each retailer. In this embodiment, several computers cooperate to effect the purchase and delivery—the credit card company's computer posts debits to the credit card account, the retail facility customer database (60 of FIG. 5, see below) is queried to obtain delivery instructions, and the information from these two databases is combined to formulate a delivery order to be posted to one or more retailer's merchandise order computer.

Whether purchasing stations 18 are provided individually by each retailer, or purchasing stations 16 are provided as a common facility for all retailers, the pages displayed on purchasing station 16, 18 may include advertising. The advertising may highlight an individual retailer, a product offered by one or more of the retailers, a clothing designer, or a product like Coca-Cola that is advertised in many other media. The purchase process may collect point-of-sale information, allowing retailers better to forecast consumer buying trends.

Wiring for purchasing stations 16, 18 may be provided in the floor and/or walls. The infrastructure for the wiring may be chosen to allow ready reconfiguration or redistribution of purchasing stations 16, 18. The wiring infrastructure may use the techniques commonly used in reconfigurable office panel systems, or raised flooring of the type used in computer data centers; or other technologies. The purchasing stations may be connected to their host computers using copper wire, fiber optic lines, or other fixed media. Alternatively, purchasing stations 16, 18 may be connected by a wireless network, for instance using radio, infrared or ultrasonic signal media.

One or more stores 14 in retail facility 10 may be full-size, full-inventory stores, with electronic purchasing stations 16, 18 and/or PSDs 52 available to those customers that prefer them. For instance, electronic purchasing stations 16, 18 and PSDs 52 acting in conjunction with DSN network 102 may supplement human personnel with product information at a level of detail that is beyond the knowledge of sales personnel.

Optionally, purchasing stations 16, 18 and PSDs 52 may offer a broader range of merchandise than can be fit in the particular store 14, or may provide access to items that are out of stock at that store 14. Purchasing stations 16, 18 and PSDs 52 may be available when all personnel are busy. Purchasing stations 16, 18 and PSDs 52 are especially convenient for the purchaser who wants the merchandise delivered, rather than taking immediate possessory delivery and having to carry it away from store 14.

A customer may derive the combined benefits of both the traditional retail channel (the opportunity to “test drive” the physical merchandise, and post-sale customer service) and internet retailing (richer, more detailed product information, and convenience, for instance, shopping at home), and may obtain additional benefits unobtainable with either alone (integrated access to many retailers).

A retail facility capability can be added to the typical auto show, boat show, or other consumer or business-to-business trade show. A DSN network may be installed on the premises of the consumer or business trade show, enabling consumers to use PSDs 52 and/or purchasing stations 16, 18 to buy the merchandise that is on display.

Affinity or loyalty programs may be offered. Under one exemplary loyalty program, purchases in retail facility 10 may earn points for goods or services, for instance, purchases at retail facility 10. An Internet web site may provide customers access to their loyalty point accounts. Customers may be able to create their own home pages with account information; this information may be released to retailers or to other customers, as the customer authorizes.

Purchases can be delivered by common carriers (United States Postal Service, Federal Express, United Parcel Service, etc.). A retail facility 10 in an urban area may provide delivery by bicycle messenger for relatively small articles. Retail facility 10 may provide a pick-up center shared by all retailers in retail facility 10. The developer or operator of retail facility 10 may coordinate the pick-up center or delivery messenger service, and include the cost in the monthly lease fee. Alternatively, retailers 14 may organize these fulfillment services cooperatively. Alternatively, each retailer 14 may ship merchandise from its own warehouse, with very little coordination among retailers 14, or between the developer/operator and the retailer. Pick-up may be an attractive option when major attraction 12 attracts people on a recurring basis. For instance, a person that holds a season ticket for games played at adjoining arena 12 may make a purchase at retail facility 10 while attending a game on Monday, and arrange to have the merchandise available for pick-up on Thursday, when the person expects to be back at the arena 12 and retail facility 10 for the next game.

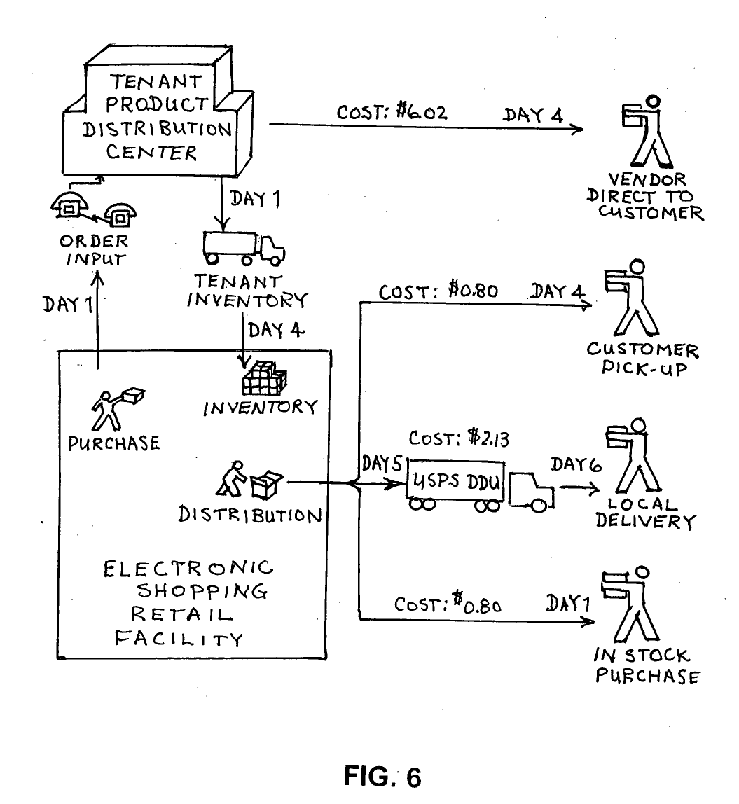

An integrated electronic shopping system as described herein provides a low cost alternative for merchants or retailers to direct-ship purchases to customers at substantial savings compared to regular transportation rates. Merchants can substantially reduce shipping charges on “ship-to” purchases by using this shipping solution. The electronic shopping system also provides merchants with lowest cost means of transporting merchandise to store for floor samples, inventories for sale, etc. A proprietary package transit and tracking system may be combined with arranged transportation contracts with each merchant, utilizing the USPS for package deliveries within 25 miles of each shopping facility. In such an environment, each merchant may have the ability to ship packages to customers free of shipping and handling charges. The shipping options are illustrated in FIG. 6.

A retail facility 10 may provide a retailer with a low-cost way to enter a new market. For instance, to establish a traditional retail presence in a new country, a retailer may have to clear a number of issues: taxes, duties, agricultural import restrictions, transportation and logistical infrastructure, leases, banking, etc. In order to amortize these costs over a large enough base, a typical retailer seeks to open a number of stores in a new market all at once. This entry barrier may be lowered by retail facility 10—once the goods for display have cleared customs, there is little continuing importation or distribution. A retailer may deal with customs and tax issues on a per parcel basis, using mechanisms already established by the seller, buyer, or shipper. Thus, a retail facility in Toronto may give American retailers an entree to the Canadian market, or a retail facility in Miami may give European retailers an entree to the American market, where that retailer would be unable to mount the resources to open a number of traditional retail stores.

Some aspects of retail facility 10 may be applicable in a single department in a large traditional department store, or to establish a single store in a traditional mall. For instance, a cosmetics counter in a large department store, or a free-standing cosmetics store 14 in a traditional mall, may be established with a single tester bottle of each cosmetic to be sold, or a single bottle giving a representative sample of the fragrances, lotion consistencies, colors, etc. of the cosmetics. Store 14 may have a web site that catalogs all of the products of all of the lines offered. A customer can make an informed choice based on the tester samples, and place an order for delivery at purchasing station 18 in the cosmetics store.

In one alternative embodiment, the rental fee may be closer to a single flat monthly fee, varying with square footage and anticipated utilities use. The developer may forego the traditional percentage-of-sales fee. The monthly fee would include space, common area charges, the computer infrastructure (the server computers, the wiring or fiber optic connection, possibly support software, and support), the build-out of walls, utilities distribution, etc. Such a flat monthly fee provides tenants with more predictability than the traditional fee structure for mall tenants, and may be more attractive to tenants who are willing to experiment with a new style of retailing, and who anticipate reconfiguring their space more frequently than is traditional. Marketing fees may be bundled into the flat fee, or charged separately.

In an alternative, the developer or operator of retail facility 10 charges a single monthly fee, and the amount of the fee varies, for instance, to reflect inflation. In an alternative, the fee may be calibrated to the head count of the number of customers that enter retail facility 10.

In another alternative, the terms of a space lease for retail facility 10 are relatively similar to the lease terms for a retail space in a traditional mall. The rent may be based on a square footage charge and a percentage of sales, with certain contractual minimum amounts, plus cooperative marketing fees, etc. The lease may grant the tenant a sole-occupancy lease for the retail space, and common occupancy for common areas (the center court and hallways of FIG. 2, shipping docks, etc.). The retail facility operator may provide typical mall services, for instance maintenance, cleaning, security, lighting, air conditioning, snow plowing, insurance, etc. In addition, the retail facility operator may provide common area purchasing stations 16, and a server computer to host the retail facility web site and one or more of the retailers' web sites. The costs for the common areas and services are pro-rated to the individual retail tenants.

In another alternative, the functions of retail facility 10 may be more centralized in the developer than is traditional in a traditional mall. For instance, the space may be leased in a more “built out” condition, with a finished shell, and utilities distribution.

Space in retail facility 10 may be auctioned, for instance using one of the Internet auction sites. Retailers may coordinate the operations of their traditional retail stores with their stores in retail facility 10. Advertising expenditures and strategic branding campaigns may be leveraged across an electronic retail channel, a traditional channel, or both, improving a retailer's ability to convey its brand identity and message. A retailer that currently operates only over the Internet may be able to establish a physical presence at an affordable cost, and vice versa. Some retailers may use a physical store in retail facility 10 to provide traditional customer services, such as merchandise return, to customers that originally made their purchases electronically. The retailer may use the physical presence of a store in retail facility 10 to provide “360 degree” customer service to its customers who originally purchased goods over the internet; thus; the concept of the retail facility may be called “e-mail 360.” A retail facility may be used to market to the population of people that are comfortable with technology. Retailers that exploit both the internet and traditional retail channels may have access to more information on their customers, and additional sales opportunities, opportunities to provide service to customers, and the opportunity to build lasting relationships. By exploiting both the internet channel and the traditional channel, and the opportunities opened by the combination, retailers may obtain the improved reach and segmentation benefits of direct marketing, and the personal interaction, merchandising innovation, and ambiance of a traditional retail store, and the immediacy and interactivity of the internet.

The retail facility web site of the individual retailers' web sites may allow a customer to inquire as to the status of an order, which may be particularly valuable in the context of custom manufactured orders.

As depicted in FIG. 5, a PSD 52 comprises a hand-held casing 122, a scanner 124 mounted to the casing for reading product codes on displayed products, a wireless receiver 126 mounted to the casing, a wireless transmitter 128 mounted to the casing, a manual input interface 130 on the casing, and a control microprocessor 132. Microprocessor 132 is mounted to casing 122, is operatively coupled to scanner 124, receiver 126 and transmitter 128, and is programmed to (a) download receive, from dedicated electronic shopping network 102, product information pertaining to products identified via scanner 124, (b) construct a list of items identified via the scanner, and (c) transmit, to the dedicated electronic shopping network 102, a single purchase request for multiple items on the list. A display 134 is mounted to casing 122 and operatively coupled to microprocessor 132 for displaying product information downloaded from the dedicated electronic shopping network 102. Microprocessor 132 includes a memory 136 and software for storing personal identification information pertaining to a user of the device.

PSD 52 stores, in memory 136, personal identification information pertaining to at least one individual authorized to use the personal shopping device. The personal shopping device may additionally store at least one delivery option selectable by the one individual and transmittable to the electronic shopping network 102 to specify delivery particulars.

As discussed above, terminals such as kiosks and personal shopping devices may communicate with dedicated servers 110 from within a shopping area, and the servers may be generally connected to the Internet for credit card processing only. In the event that the dedicated store servers are able to otherwise access a public website, it is generally not for any other purpose directly associated with shopping or purchasing product. For example, the dedicated servers 110 might be provided with an address or zip code lookup through Yahoo, or other electronic service provider. In addition, the dedicated servers 110 may first go through a private connection to a corporate data center that would then have a more secured route out to the public Internet.

Each PSD 52 communicates with central DSN server 110 servicing a plurality of independent retailers in a mall or shopping center environment. The respective customer's electronic cart is stored on central DSN server 100, thus eliminating the need for PSDs 52 to have substantial amounts of memory. PSDs 52 may thus take the form of relatively unintelligent devices that store little or no data and operate as roving electronic portals for receiving product information from server 110 and for creating or filling electronic shopping carts in a mall or shopping center environment. If a customer has created a shopping cart using PSD 52 and wants to complete a purchase through a kiosk or by asking a human shopping assistant for help, a scan of a barcode on the PSD 52 triggers transmission of the customer's cart information to the kiosk, cash register, or shopping assistant's handheld device. If the customer has registered with server 110 or an overarching service provider by supplying a user ID and PIN, then the customer can also access his or her shopping cart (purchase list) from home via server 110 or a website of the shopping service provider. This is because the customers' shopping carts are stored on server 110.

It is not contemplated that retailers have access to database 104. Rather server 110 transmits to the retailers all of the customer data necessary to fulfill their respective orders. Also, the retailers' computers that will receive this data can be located anywhere and would most likely exist at the retailers' corporate data centers.

An electronic shopping network, whether implemented via DSNs 102 or solely through the Internet 108, may include one or more of the following features.

The customer may be provided with the ability to do self-checkout of both take-home and orders for shipment in a single shopping session on a PSD 52. The electronic shopping system will perform the single checkout on the PSD 52 using customer information (name, billing address, shipping address, credit and debit card numbers, credit history, etc.) on file, for example, in a central data base accessed via a system wide computer (not shown) servicing multiple shopping networks such as DSNs 102.

A customer may start a shopping session using a handheld PSD 52 and finish the shopping session at an electronic purchasing station or kiosk 16, 18. The customer may scan all her items for take-home, walk to a printer or a self-checkout kiosk, scan the device and obtain a receipt immediately. Alternatively, the customer may scan some items for take-home and some for delivery to a location specified by the customer. In that case, the customer's receipt may specify only those items purchased for take-home.

For security purposes, at a kiosk 16, 18 a shopper assistant can scan a customer's receipt and perform a quick audit on the customer's PSD 52 (e.g., “you bought 3 items totaling $150”).

The customer may have the ability to scan items into a PSD 52 for home delivery or take home and then take the device to a traditional cash register (POS) or mobile POS handheld device. At the register, a sales associate can scan an ID on the customer's PSD 52, or scan the POS device with the customer's PSD, thereby transferring the shopping cart to the POS. At that point, the sales associate can finish the transaction for the customer.

At the cash register, the sales associate can access a customer's profile, retrieving address book information, as well as various credit cards that the customer may have entered into her profile. This makes it easier for sales associates to place orders for customers at the cash register.

A sales associate can perform all of the above functions using a mobile handheld device generally similar to PSD 52 anywhere on the sales floor.

The above-described shopping network technology can be licensed to a specific retailer having a geographic dispersion of retail locations. In this case, there can be a “cross-use” of PSDs 52 among multiple retailer locations. For example, a customer may save a shopping session started at one of the retailer's stores and finish the session at a different location.

An electronic shopping system may have the ability to make product recommendations based on a particular customer's shopping history. Customer profiles may be kept in a central or distributed database for this purpose.

A customer may scan an item via PSD 52 to take home and access the Internet 108 either directly or via server 110 see if other sizes/colors of that item are available for home delivery.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A business method comprising:
providing a dedicated electronic shopping network having a database and wireless receiving and transmitting components;
providing a retail-type architectural facility;
renting out space in said facility to a plurality of independent retail entities;
for each respective one of said retail entities, loading into said database data pertaining to goods offered for sale by said respective one of said retail entities;
receiving, via said wireless receiving components, queries from hand-held electronic personal shopping devices pertaining to goods offered for sale by said retail entities; and
transmitting, via said wireless transmitting components, to said hand-held electronic personal shopping devices, data from said database responsive to respective ones of said queries.

2. The method defined in claim 1, further comprising:
receiving, from a given one of said personal shopping devices via said wireless receiving components, a purchase request including a specification of delivery particulars and payment particulars;
electronically relaying said payment particulars to a specified financial institution; and
confirming payment completion to said given one of said personal shopping devices via said wireless transmitting components.

3. The method defined in claim 2 wherein said dedicated electronic shopping network includes a server computer having a connection to the Internet, the relaying of said payment particulars including operating said server computer to communicate with a computer of said specified financial institution via the Internet.

4. The method defined in claim 3, further comprising blocking said personal shopping devices from having direct access to the Internet via said dedicated electronic shopping network.

5. The method defined in claim 2 wherein said purchase request includes a listing of goods sold by different retail entities, the relaying of said payment particulars including a specification of amounts due to the different retail entities, said payment particulars including a single total amount entailing a single monetary transfer for each of the different retail entities.

6. The method defined in claim 1 wherein at least a given one of said personal shopping devices stores personal identification information pertaining to at least one individual authorized to use said given one of said personal shopping devices.

7. The method defined in claim 6 wherein said given one of said personal shopping devices stores at least one delivery option selectable by said one individual and transmittable to said electronic shopping network to specify delivery particulars.

8. The method defined in claim 1, further comprising: receiving, from a given one of said personal shopping devices via said wireless receiving components, an aggregated purchase request pertaining to a plurality of products each for sale by a respective one of said retail entities; communicating with a specified financial institution to complete a purchase transaction on said plurality of products in response to a single instruction from said given one of said personal shopping devices.

9. The method defined in claim 1 wherein the renting out of space in said facility includes providing a package of support services to each of said retail entities, said package including at least two services taken from the group consisting of design services, construction services, personnel services, tax and regulatory services, and delivery services.

10. An electronic shopping system comprising:
a dedicated electronic shopping network having a database and wireless receiving and transmitting components,
said receiving and transmitting components being disposed in operative proximity to a retail-type facility housing retail displays of a plurality of independent retail entities,
said network including a dedicated database storing data pertaining to goods offered for sale by said retail entities,
said network including software for fielding queries received, via said wireless receiving components, from hand-held electronic personal shopping devices pertaining to goods offered for sale by said retail entities,
said network further including software for transmitting, via said wireless transmitting components, to said hand-held electronic personal shopping devices, data from said database responsive to respective ones of said queries.

11. The system defined in claim 10 wherein said dedicated electronic shopping network is provided with software for recognizing a purchase request received from any given one of said personal shopping devices via said wireless receiving components, said software including programming for recognizing delivery particulars and payment particulars, electronically relaying said payment particulars to a specified financial institution, and confirming payment completion to said given one of said personal shopping devices via said wireless transmitting components.

12. The system defined in claim 11 wherein said dedicated electronic shopping network includes a server computer having a connection to the Internet for communicating with a computer of said specified financial institution via the Internet.

13. The system defined in claim 12 wherein said dedicated electronic shopping network is provided with software for blocking said personal shopping devices from having direct access to the Internet via said dedicated electronic shopping network.

14. The system defined in claim 11 wherein said dedicated electronic shopping network includes programming for processing a purchase request including a listing of goods sold by different retail entities, for relaying said payment particulars including a specification of amounts due to the different retail entities, said payment particulars including a single total amount entailing a single monetary transfer for each of the different retail entities.

15. The system defined in claim 10 wherein at least a given one of said personal shopping devices has access to personal identification information pertaining to at least one individual authorized to use said given one of said personal shopping devices.

16. The system defined in claim 15 wherein said given one of said personal shopping devices has access to at least one delivery option selectable by said one individual and transmittable to said electronic shopping network to specify delivery particulars.

17. A personal shopping device comprising:
a hand-held casing;
a scanner mounted to said casing for reading product codes on displayed products;
a wireless receiver mounted to said casing; a wireless transmitter mounted to said casing;
a manual input interface on said casing;
a control microprocessor mounted to said casing, operatively coupled to said scanner, said receiver and said transmitter, and programmed to:
(a) receive, from a dedicated electronic shopping network, product information pertaining to products identified via said scanner,
(b) construct a list of items identified via said scanner, and
(c) transmit, to said dedicate electronic shopping network, a single purchase request for multiple items on said list; and
a display mounted to said casing and operatively coupled to said microprocessor for displaying product information received from said dedicated electronic shopping network.

18. The device defined in claim 17 wherein said microprocessor includes a memory and software for storing personal identification information pertaining to a user of the device.

19. A shopping method comprising:
providing a hand-held electronic personal shopping device;
visiting a retail location provided with a dedicated electronic shopping network;
operating said personal shopping device to wirelessly transmit a request to said dedicated electronic shopping network for information pertaining to an identified product on display at said retail location;
operating said personal shopping device to wirelessly receive the requested information from said dedicated electronic shopping network;
operating said personal shopping device to communicate the received information;
generating a list of goods to be purchased; and
transmitting a single purchase request for goods on said list.

20. The method defined in claim 19 wherein said goods include goods sold by different retail entities.

21. The method defined in claim 19 wherein the transmitting of said purchase request is to said dedicated electronic shopping network and is performed at said retail location

22. The method defined in claim 19 wherein the transmitting of said purchase request is via the Internet from a location remote relative to said retail location.

23. The method defined in claim 19, further comprising automatically blocking access by said personal shopping device to the Internet via said dedicated electronic shopping network.

24. The method defined in claim 19, further comprising receiving personal identification information into said personal shopping device and operating said personal shopping device to recognize an authorized user in accordance with the received personal identification information.

25. A business method comprising:
providing a retail-type architectural facility;
renting out space in said facility to a plurality of independent retail entities, the renting out of space in said facility including providing a package of support services to each of said retail entities, said package including design services, construction services, personnel services, tax and regulatory services, and delivery services;
for each of said retail entities, receiving samples of a plurality of different products; and
for each of said retail entities, displaying the respective products in said facility.

26. The method defined in claim 25, further comprising:
providing a dedicated electronic shopping network having a database and wireless receiving and transmitting components; and
for each respective one of said retail entities, loading into said database data pertaining to respective displayed product samples.

27. The method defined in claim 25, further comprising:
receiving, via said wireless receiving components, queries from hand-held electronic personal shopping devices pertaining to goods offered for sale by said retail entities; and
transmitting, via said wireless transmitting components, to said hand-held electronic personal shopping devices, data from said database responsive to respective ones of said queries.

28. An electronically implemented shopping method, comprising:
providing a handheld personal shopping device having a scanner;
operating the shopping device to scan in product identification information at a first retail facility at a first location;
subsequently carrying said personal shopping device to a second retail facility at a second location remote from said first location;
operating said personal shopping device at said second location to scan in additional product information at said second retail facility; and
subsequently completing a purchase transaction involving at least one product having information scanned into said personal shopping device at said first retail facility and at least one product having information scanned into said personal shopping device at said second retail facility.

29. The shopping method defined in claim 28 wherein the completing of said purchase transaction is carried out at said second retail facility.

30. The shopping method defined in claim 29 wherein the completing of said purchase transaction includes transmitting purchase order particulars over a wireless connection at said second retail facility.

31. The shopping method defined in claim 28 wherein said first retail facility and said second retail facility are retail establishments under common control and ownership.
